(19) United States
(12) Patent Application Publication
(10) Pub. No.: US 2015/0248217 A1
(43) Pub. Date: Sep. 3, 2015

(54) SLIDING ROW DISPLAY OF INFORMATION

(71) Applicant: CA, Inc., Islandia, NY (US)

(72) Inventors: Yingwei Cai, Beijing (CN); Lizeng Zhang, Beijing (CN); Guoqiang Zhang, Beijing (CN)

(73) Assignee: CA, Inc., Islandia, NY (US)

(21) Appl. No.: 14/193,952

(22) Filed: Feb. 28, 2014

(51) Int. Cl. G06F 3/0484; G06F 3/0488

(52) U.S. Cl. CPC G06F 3/04842; G06F 3/04883

(57) ABSTRACT

A method, system, and computer program product for displaying information on a display screen associated with an electronic device is disclosed. In one aspect, the information includes a number of objects such as various news articles, e-mail messages, etc. A portion of each of the objects may be presented in its own row on the display screen. The user can select one of the objects and slide it in its row to see different portions of the object. While the user is moving through the object by sliding one row, the other rows may remain fixed.

### BACKGROUND

The present disclosure relates to displaying information on an electronic device. While this disclosure is not limited to any type or size of electronic device, it is more challenging to present information on smaller display screens of devices such as, but not limited to, cellular telephones and notepad computers.

One particular problem is that some applications have many different elements that contain information that may or may not be of interest to a user. For example, an email application may contain many received email messages. The application can present a list of the emails with some very small portion of the email content such as the name of the sender, date the message was received, and perhaps a small bit of additional information. It can be difficult for a user to go through all of the emails in an efficient manner, especially on a relatively small display screen. One possible technique is for the user to select one of the messages to view the contents therein. This typically results in the content of the selected message replacing the list of messages.

### BRIEF SUMMARY

According to one aspect of the present disclosure objects are displayed on a display screen. The method of one embodiment comprises the following. Object are displayed on a display screen associated with an electronic device. Each of the objects comprises sequential portions. The displaying comprises displaying a first portion of each object in a row that is associated with that object. The first portion of each object comprises non-sequential items. Input is received at the electronic device that selects a first object of the objects and that indicates either a first direction or a second direction to move within the first object. A second portion of the first object that corresponds to the direction of the move is accessed. The second portion of the first object comprises a second plurality of non-sequential items. The first portion is removed from the display screen responsive to the input while continuing to display the first portion of the rest of the objects in their respective rows. The second portion is added to the display screen in the row of the selected object responsive to the input while continuing to display the first portion of other objects in their respective rows.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 illustrates a diagram of an environment in which embodiments may be practiced.

FIG. 2 is a diagram that shows one embodiment of the electronic device of FIG. 1.

FIG. 3 represents an object, which is displayed on display device in accordance with embodiments.

FIG. 3A, FIG. 3B, and FIG. 3C show how a user can move through a selected object, in accordance with one embodiment.

FIG. 4 is a flowchart of one embodiment of a process of displaying information on a display screen.

FIGS. 5A-5L show several additional examples of how the user can move through selected objects.

FIGS. 6A-6C shows another example of moving through an object, in accordance with embodiments.

FIG. 7 illustrates a high level block diagram of a computer system which can be used to implement the technology described herein.

### DETAILED DESCRIPTION

The present disclosure relates to displaying information on a display screen associated with an electronic device. In one embodiment, the information includes a number of objects such as various news articles, e-mail messages, etc. For the sake of discussion, each message or news article may be referred to herein as an “object.” A portion of each of the objects may be presented in its own row on the display screen. The user can select one of the objects and slide it in its row to see different portions of the object. While the user is moving through the object by sliding one row, the other rows may remain fixed. For example, a user can slide one row to move through a news article while titles of other news articles remain fixed in their rows. Therefore, the user does not need to leave the view that shows the title of each article in order to view the selected article. Many other implementations are possible.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

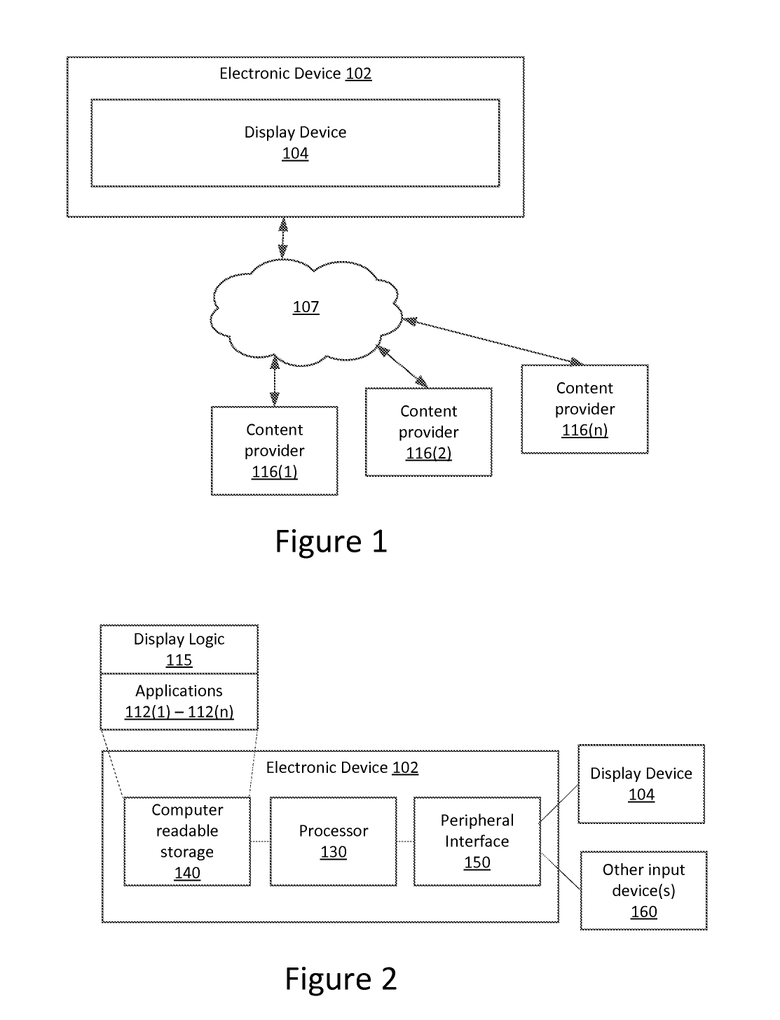

FIG. 1 is a diagram of an environment in which embodiments may be practiced. In one embodiment, the electronic device 102 is a mobile device. The electronic device 102 can be, but is not limited to, a cellular telephone, a notepad computer, a laptop computer, a camera, a smart telephone, a media player, a navigation device, an email device, and a game console.

The electronic device 102 can communicate over one or more wired and/or wireless networks 107. The network(s) 107 can include, e.g., the Internet, a cellular network, a wide area network, and/or a local area network. In some embodiments, the electronic device 102 can send and receive emails over network 107. In some embodiments, the electronic device 102 can receive documents such as Web pages over network 107. In some embodiments, the electronic device 102 can receive photographs, videos, or other media over network 107. In some embodiments, the electronic device 102 can place and receive phone calls over network 107.

The various content providers 116(1)-116(n) refer to, for example, media services, messaging services, navigation services, etc. Thus, the providers 116(1)-116(n) may provide emails, news articles, Web pages, images, videos, etc. The information provided by these providers (as well as other information) is presented on the display device 104 in various embodiments.

FIG. 2 is a diagram that shows some details of one embodiment of the electronic device 102. The electronic device 102 includes a processor, computer readable storage, and a peripheral interface.

The electronic device 102 is communicatively connected to display device 104. The display device 104 may also be referred to as a display screen. There may be a wired or wireless communication link between the electronic device 102 and display device 104, for example. The display device 104 might be physically integrated with the rest of the electronic device 102 (such as with many cellular telephones and notepad computers). Alternatively, the display device 104 might be physically separate from the electronic device 102. Embodiments disclosed herein provide for efficient techniques of displaying information on the display device 104. In some cases, the display device 104 is relatively small, which can complicate displaying information. However, embodiments are not limited to any particular size of display device 104.

The display device 104 is a touch-sensitive display in one embodiment. The display device 104 can be implemented using a variety of technologies including, but not limited to, liquid crystal display (LCD) technology, light emitting polymer display (LPD) technology, or some other display technology. The display device 104 can be sensitive to haptic and/or tactile contact with a user. Such a display allows for input by, for example, a user swiping their finger across the display device 104. Other touch-sensitive display technologies can also be used, such as a display in which contact is made using a stylus or other pointing device.

The display device 104 and peripheral interface 150 can, for example, detect contact and movement or break thereof using a variety of touch sensitivity technologies, including but not limited to capacitive, resistive, infrared, and surface acoustic wave technologies, as well as other proximity sensor arrays or other elements for determining one or more points of contact with the display device 104.

The electronic device 102 has several applications 112(1)-112(n) stored within computer readable storage 140, which from time to time may initiate the display of information on the display device 104. Examples of the applications 112 include, but are not limited to, an email application, a web browser, and a news application. In one embodiment, applications 112 are software applications that are executed on the processor 130.

The display logic 115 controls the display of the information on the display device 104. The display logic 115 organizes the information in rows of objects in one embodiment. The display logic 115 includes instructions stored in the computer readable storage 140, in one embodiment.

The peripheral interface 150 communicates with the display device 104 to control the display of the information on the display device 104. In one embodiment, the peripheral interface 150 receives user input from the display device 104. For example, a user can touch the display device 104 to provide input.

Other input devices 160 are also depicted. These can also allow the user to provide input to control the display of objects on the display screen 104. Other input devices could include a microphone, which may allow a voice interface.

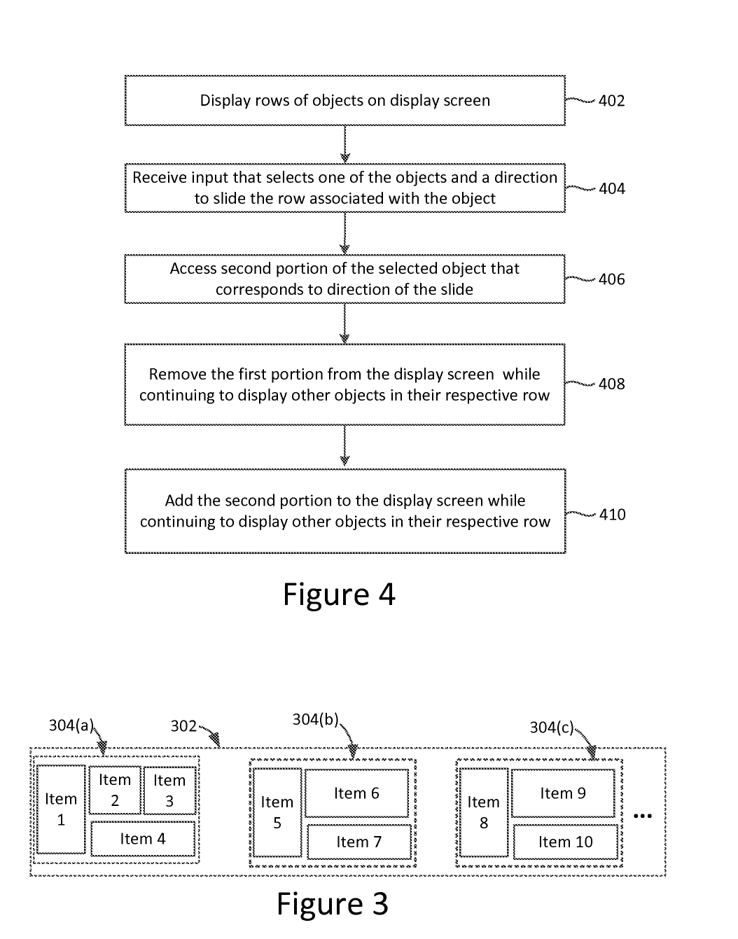

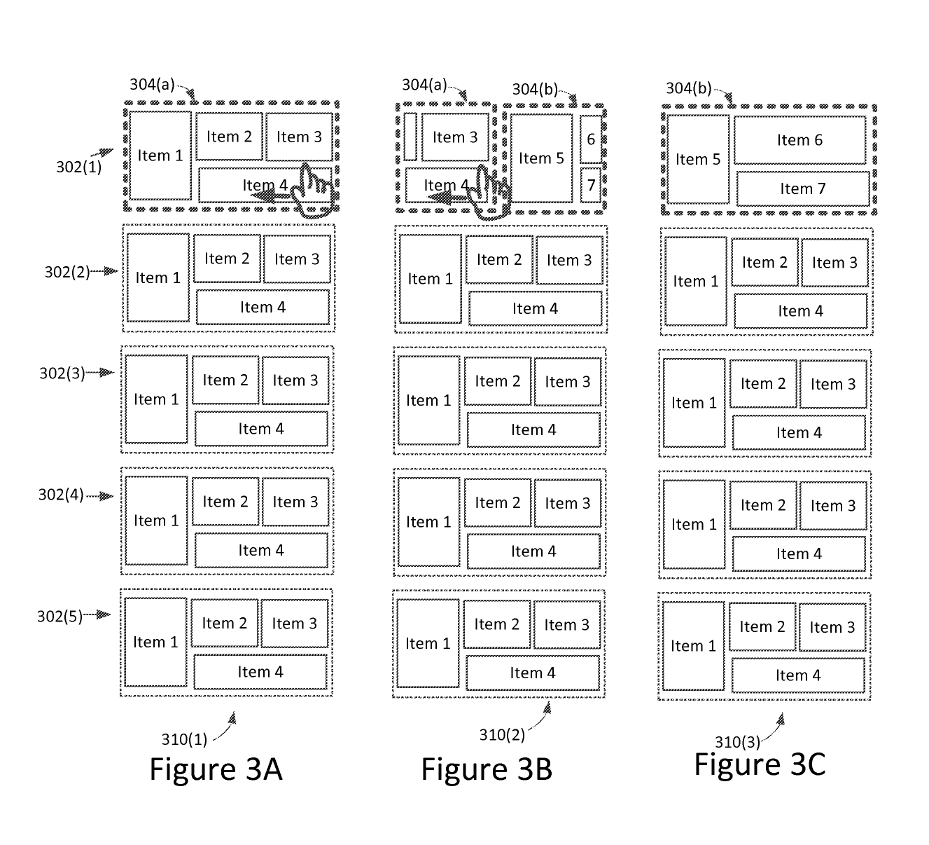

FIG. 3 represents an object 302, which is displayed on display device 104 in accordance with embodiments. As examples, the object 302 may correspond to various content associated with one email message, one news article, etc. The object 302 includes several portions 304(a)-304(c), in this example. Only one portion 304 of the object 302 is displayed at a time, in accordance with embodiments. However, typically one portion of multiple objects 302 are shown together, as will be explained below.

In the example of FIG. 3, portion 304(a) has four items. For the sake of illustration, item 1 might be an image, and items 2-4 might have some textual content (e.g., title, date, message content, sender of message, etc.). At least some of these items are non-sequential items, in one embodiment. By non-sequential it is meant that there is not a required order between the non-sequential items presently being displayed. For example, the non-sequential items could be re-arranged in the display without destroying the meaning of the content. As one example, one item could be an image and another item could be text. As one example, the image could be moved from the left side to the right side of the display without destroying the meaning of the content conveyed by the text and the image.

Portion 304(b) has a different set of items relative to portion 304(a). In this example, portion 304(b) has item 5-item 7. At least some of these items may also be non-sequential items. If the user were going through a news article, item 5 might be a different image from item 1. Item 6 might be additional text of the news article. Note that the number of items can change from one portion 304 to the next portion 304.

Portion 304(c) has yet a different set of items (Items 8-10), in this example. For example, item 8 could be a different image than was previously shown to the user. However, note that it is possible that the content of an item can be the same for two different portions 304. For example, the same image might be shown for Item 8 and Item 5. The object 302 could have more or fewer than three portions.

FIGS. 3A-3C show how a user can move through a selected object 302, in accordance with one embodiment. Each of these figures shows content is presented on the display device 104 at one point in time, as indicated by reference numerals 310(1)-310(3). There are five objects 302(1)-302(5) in this example. For the sake of discussion, each of these objects has the same format as the object 302 in FIG. 3. It will be understood that only one portion 304 is each object is displayed at time. As examples, each row may correspond to various content associated with one email message, one news article, etc.

Each object 302 is associated with one row, such that the user is able to move through the various content in a selected object by sliding the row. For example, FIG. 3A shows that the user has selected object 302(1). The hand and arrow that are shown in FIG. 3A represent the user's hand and a direction of the hand's movement. The hand is not part of what is displayed on the display screen 104. The hand is one example of how a user can provide input. The user might use some other body part or a prop. This example is for a touch screen, but the display device 104 is not required to be a touch screen.

In FIG. 3A, portion 304(a) of object 302(1) is being displayed. FIG. 3B shows that the user is in the process of sliding the selected object 302(1) to the left. At this point, some of portion 304(a) and some of portion 304(b) is being displayed. FIG. 3C shows that a new portion 304(b) of the selected object 302(1) has now replaced the former portion 304(a). In a similar manner, the user can move through the other objects 302(2)-302(5).

Each of the objects 302 is divided into a number of sequential portions 304, in one embodiment. The electronic device 102 presents one portion 304 of each object 302 on the display screen at one time. Since these portions 304 may be sequential, the user can move through these portions in sequence. This is referred to herein as moving “downstream” or “upstream” through the selected object.

In some embodiments, the terms “upstream” and “downstream” are used to indicate which direction the user is moving through the object 302. Often, there is initial portion for each object that serves as a starting point. As the user moves through the object 302 to obtain additional information, “downstream” portions of the object 302 are accessed and displayed. The user can also reverse direction and move back “upstream” towards the starting point, in some embodiments.

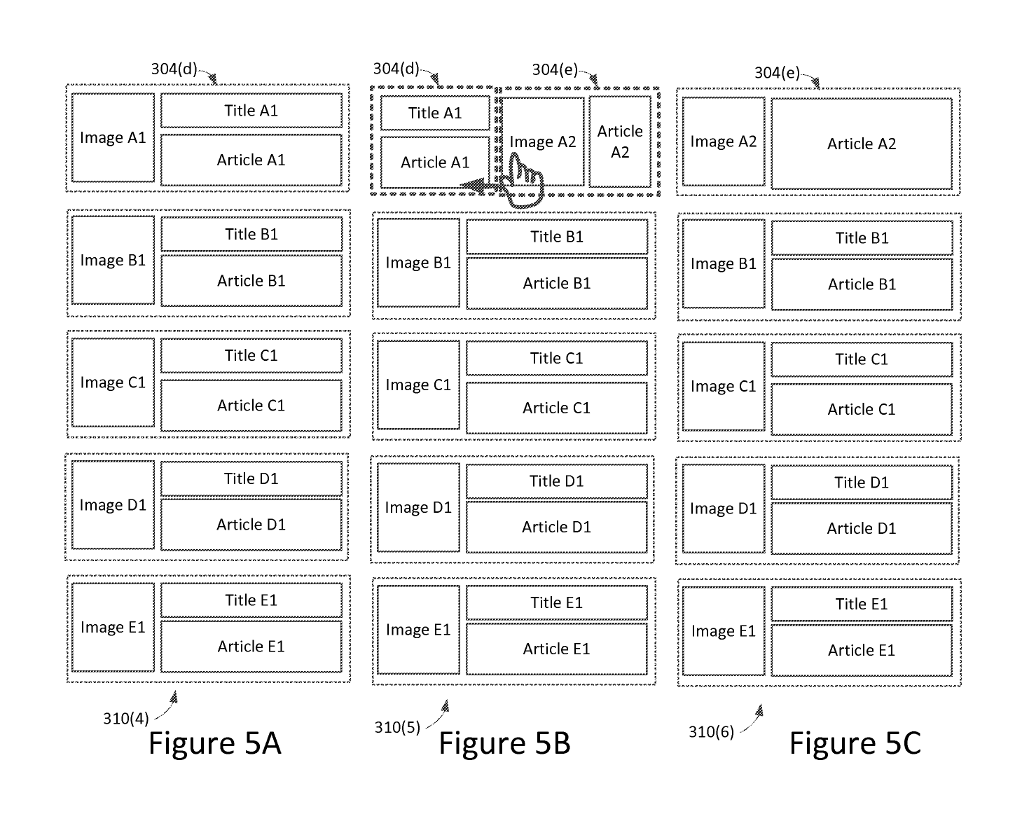

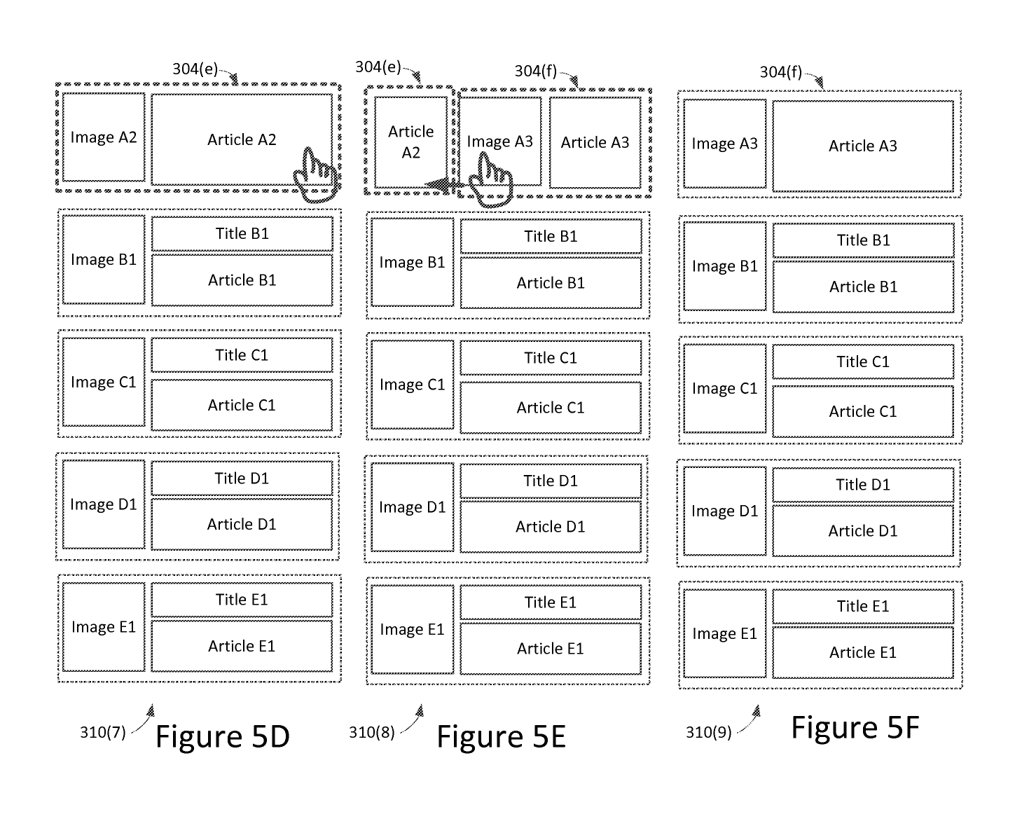

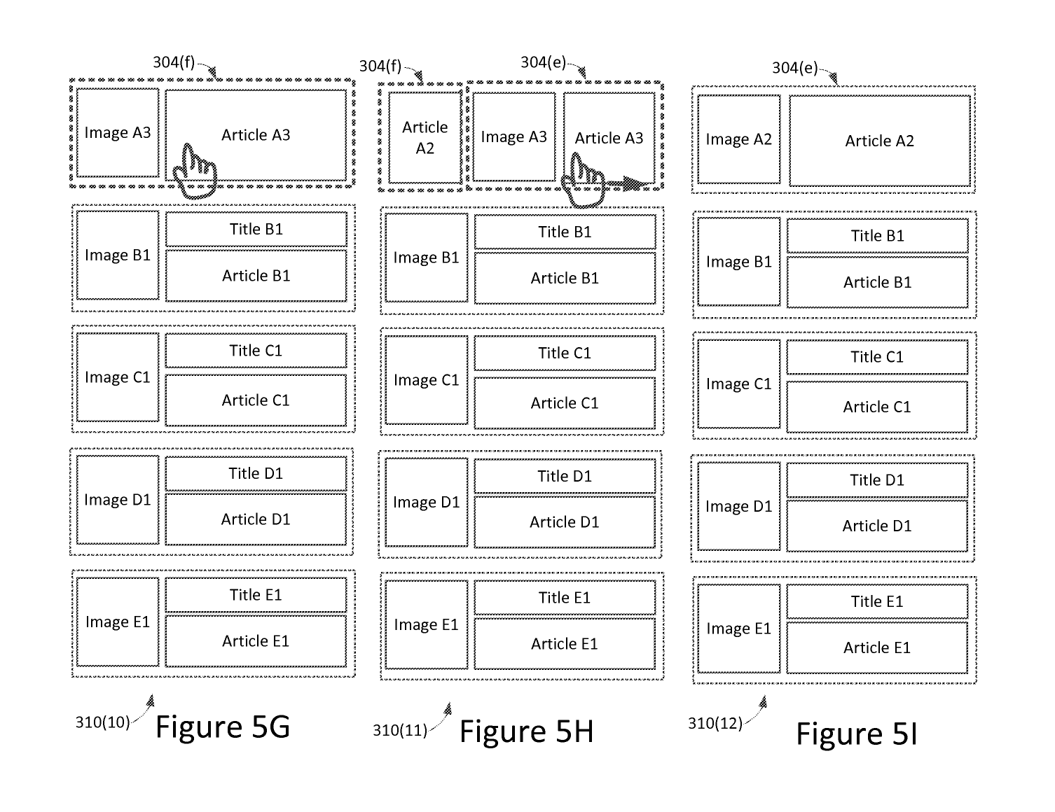

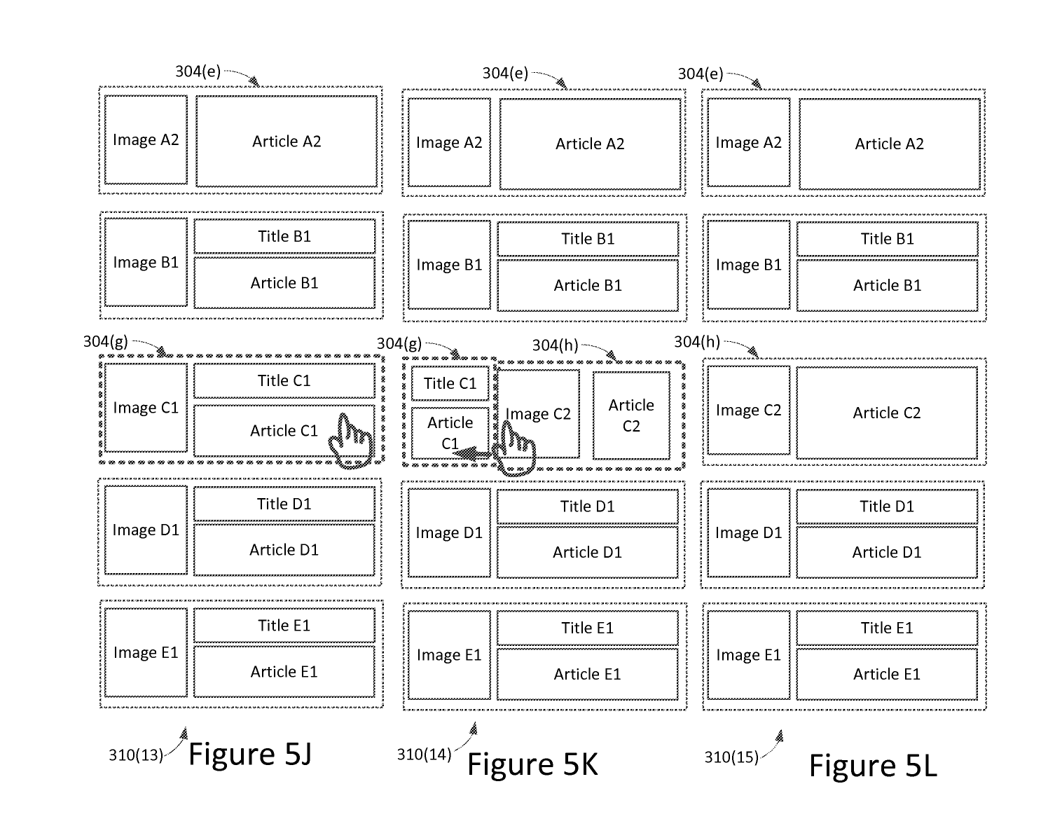

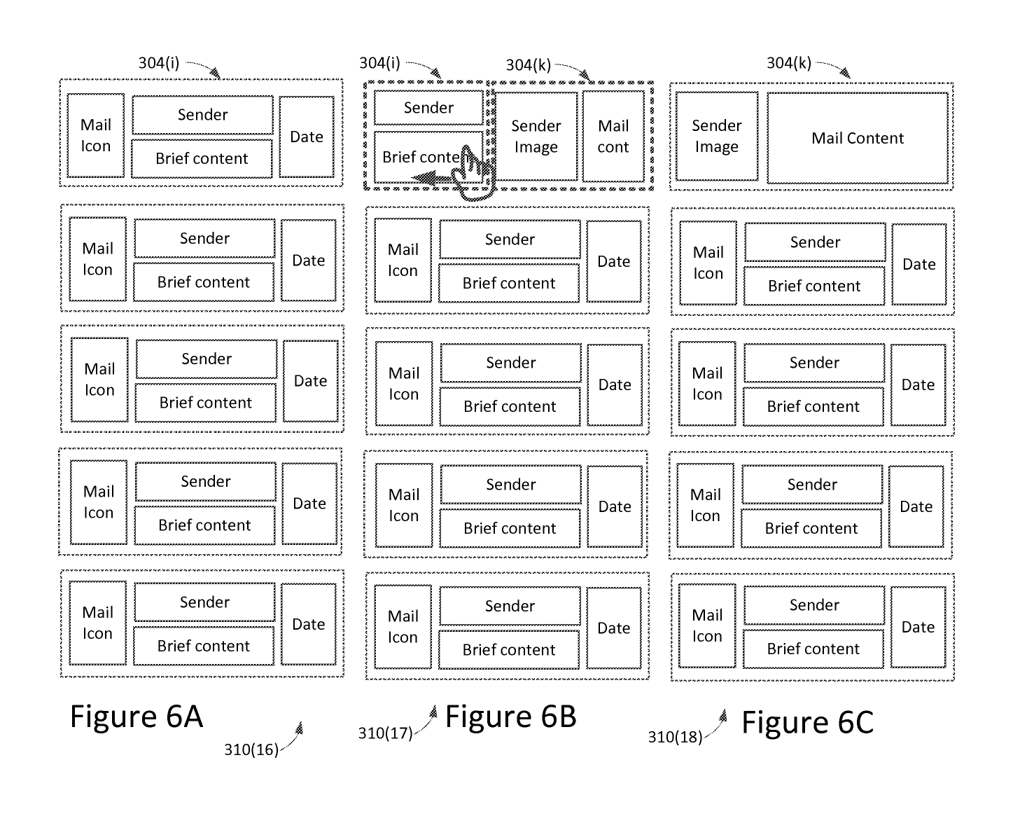

FIG. 4 is a flowchart of one embodiment of a process of displaying information on a display screen. In step 402, rows of objects 302 are displayed on a display screen 104 associated with an electronic device 102. FIGS. 3A-3C each show one example of displaying rows of objects 302. In that example, there are five rows, with a given row being “above” and/or “below” another row. As another alternative, a given row could be “left” and/or “right” of another row. Note that throughout this disclosure, references to a specific direction, such as “right”, “left”, “up” or “down” are for purposes of describing one example to facilitate a clear explanation. FIGS. 5A-5L and 6A-6C each show an additional example of displaying rows of objects 302.

In one embodiment, each of the objects comprises sequential portions, as shown in, for example, FIG. 3. A first of the sequential portions of each object may be displayed in a row that is associated with that object. The first portion of each object may comprise non-sequential items (such as an image and text). It is possible that two of the items in a given portion are sequential. For example, one item could be a title of an article and another item the beginning text of the article.

In step 404, the electronic device 102 receives input that selects one of the objects 302. The input also indicates a direction to slide a row associated with the selected object. Referring to FIGS. 3A-3C, the user can slide a row in either direction, in some though not necessarily all cases. For example, in FIG. 3C, the user may be able to slide portion 304(b) to the right to go back to portion 304(a). Alternatively, the user may be able to slide portion 304(b) to the left to go further into the object 302(1) to look another portion. However, FIG. 3A might represent an initial starting point, in which case the user might only be able to slide to the left to go “downstream” in the selected object.

In step 406, a second portion of the selected object that corresponds to the direction of the slide is accessed. For example, if the user selects portion 304(a) in FIG. 3A and starts to slide to the left, then portion 304(b) is accessed. If the user selects portion 304(b) in FIG. 3C and starts to slide to the right, then portion 304(a) is accessed. In these example, the slide is horizontal. It is not required that the user slide or move their finger (or other object) to indicate the direction. The user might also select an icon that has an arrow that indicates the direction to slide or move the object. Step 406 may result in a selection of a direction (e.g., upstream, downstream) to move within the selected object.

Steps 408-410 refer to sliding the selected object in its row to move within the selected object. These two steps may be performed together. FIG. 3B shows one example of sliding the selected object.

In step 408, the first portion is removed from the display screen responsive to the input while continuing to display the first portion of the rest of the objects in their respective rows. In one embodiment, the first portion of the selected object is slid in the selected direction responsive to the input such that the first portion is removed from the display screen. For example, the object may be slide responsive to the user dragging a finger across the display device 104. However, this is just one technique. FIG. 3C shows that the first portion 304(a) is no longer displayed.

In step 410, the second portion of the selected object is added to the display screen 104 in the row of the selected object responsive to the input while continuing to display the first portion of other objects in their respective rows. In one embodiment, the object is slid in the selected direction such that the second portion is added to the display screen. Thus, the second portion replaces the first portion in the row of the selected object. FIG. 3C shows that the second portion 304(b) is now displayed. The other objects (e.g., 302(2)-302(5)) continued to be displayed in their respective rows during steps 408-410.

FIGS. 5A-5I show several additional examples of how the user can move through selected objects 302. Each of these figures shows content is presented on the display device 104 at one point in time, as indicated by reference numerals 310(4)-310(15). For the sake of discussion, these examples may be for a news article application. FIG. 5A represents the items that are displayed for an initial portion of each of the objects. The portion 304(d) for the top object is labeled. The portions for the other objects are not separately labeled. The initial portion of each object is what the user first sees upon obtaining various news articles, in one embodiment. The initial portion contains three items for each object: an image, a title, and the beginning of the article, in this example. The initial portion is the most upstream portion, in this example.

In FIGS. 5A-5C, the object 302 in the top row is the selected object. For example, the user decides that he/she wishes to view more content of this news article and touches the display screen 104 where portion 304(d) is displayed. FIG. 5B shows that the user is sliding the selected object to the left. Some of portion 304(d) is still visible. Some of portion 304(e) is coming in to view.

FIG. 5C shows that sliding has stopped, such that the next portion 304(e) replaces the initial portion 304(d). In this example, the next portion 304(e) has two items: an image and a portion of the article. Image A2 may be different from Image A1. Article A2 refers to the same news article as Article A1, but to a later portion of the news article. There may be some overlap of the text between Article A1 and Article A2, but that is not required. That is, some part of the text from Article A1 may be displayed again in Article A2.

The user can continue to slide the object further downstream to continue to read more of the news article. This is represented in FIGS. 5D-5F. FIG. 5D shows a similar state as FIG. 5C, but shows the user selecting portion 304(e). FIG. 5E shows the object in the process of being slid. Some of portion 304(e) is still visible. Some of portion 304(f) is coming in to view. Portion 304(f) is the portion downstream from portion 304(e). FIG. 5F shows the object after sliding has stopped.

If desired, the user can slide back upstream in the selected object. For example, the user may wish to go back and review something earlier in the article or take a second look at an image that was presented earlier. This is represented in FIGS. 5G-5I. FIG. 5G shows the object in the top row being selected. FIG. 5H shows the selected object being slid to the left, which is back upstream. Some of portion 304(f) is still in view. Some of portion 304(e) is coming in to view. FIG. 5I shows that the portion 304(e) with Image A2 and Article A2 is again being presented.

At any time, the user can view additional content of another one of the objects (e.g., news articles). This is represented in FIGS. 5J-5L, in which the object in the third row from the top is selected and slid. FIG. 5J shows this object that includes portion 304(g) being selected. FIG. 5K shows this object being slid. Some of portion 304(g) is still visible. Some of portion 304(h) is coming in to view. FIG. 5L shows that sliding has stopped for the selected object. Thus, Image C2 and Article C2 are now displayed.

FIGS. 6A-6C shows another example of moving through an object, in accordance with embodiments. Each of these figures shows content is presented on the display device 104 at one point in time, as indicated by reference numerals 310(16)-310(18). This example corresponds to a message (or email) application. FIG. 6A shows that the initial portions of each object include a mail icon item, a sender item, a brief content item, and a date item. Portion 304(i) of the object in the top row is labeled; the other portions are not labeled. The mail icon might show an open envelope to show the email message has been opened, a closed envelope to show the email message has not yet been opened, etc.

FIG. 6B shows the user sliding the object to the left in which part of two portions 304(i), 304(k) are presently viewable. FIG. 6C shows that the second portion 304(k) has now replaced the first portion. In this example, the second portion 304(k) may be downstream from the first portion 304(i). As with other examples, the user may move both upstream and downstream in a given object. Also, the user can still view one portion 304 of each object while sliding through another object.

In one embodiment, the object 302 includes multiple streams of items. Referring to FIG. 3, Items 1, 5, and 8 might be part of one stream of items. These could be different Images, as one example. Items 4, 7, and 10 might be another stream of items. These might be text of an article, message etc. In one embodiment, displaying the first portion (e.g., 304(a) comprises displaying an initial item from a first stream (e.g., item 1) and an initial item from a second stream (e.g., item 4). Other items can also be displayed, which may or may not be part of a stream. For example, item 2 might not be part of a stream of items in that it is not linked or followed by a similar item in portion 304(b).

When the second portion (e.g., 304(b)) is slid, a new item from the first stream that is downstream from the initial item in the first stream is displayed. For example, item 5 is displayed. Also, a new item from the second stream that is downstream from the initial item in the second stream is displayed. For example, item 7 is displayed.

Providing for multiple streams of items in the objects provides significant benefits and solves substantial challenges. For example, with the email application depicted in FIGS. 6A-6C, it can be a challenge to display the wide variety of content associated with emails in an organized fashion in a limited amount of room. In one embodiment, the mail icon is followed in one stream of items by the sender image. The brief content is followed in another stream of items by the mail content, in one embodiment. This allows multiple types of content to be efficiently displayed.

With reference to the news application depicted in FIGS. 5A-5L, it can be a challenge to display the wide variety of content associated with news articles in an organized fashion in a limited amount of room. In one embodiment, there is one stream of items for image items, and another stream of items for text of the article. The streams do not need to be of the same length. This allows multiple types of content to be efficiently displayed. There are numerous ways in which the streams of items for a given object to be organized, such that foregoing should be viewed as examples for the purpose of illustration.

In one embodiment, the items in the same stream are displayed in the same spot in the portion 304, to the extent that is practical. For example, in FIGS. 5A and 5C, Image A1 and Image A2 are displayed in the same spot. Likewise, in FIGS. 5D and 5F, Article A2 and Article A3 are displayed in the same spot. In the mail example, the mail icon in FIG. 6A is in relatively the same location as the sender image in FIG. 6C. As one further example, in FIG. 3, items 1, 5, and 8 are presented in the same location. Likewise, items 4, 7, and 10 are presented in the same location.

As noted herein, various portion 304 of each object may comprise non-sequential items (such as an image and text). When displaying the next portion 304 of an object 302 in the sequence it could be distracting and confusing to the user if this information is not displayed in an organized manner. However, by keeping the same physical relationship between non-sequential items of the same type, the user experience is improved. For example, Image A2 is to the left of Article A2 in FIG. 5D. Likewise, Image A3 is to the left of Article A3 in FIG. 5F. Although the physical relationship between this items is not required to convey the proper meaning, maintaining such a physical relationship can improve the user experience.

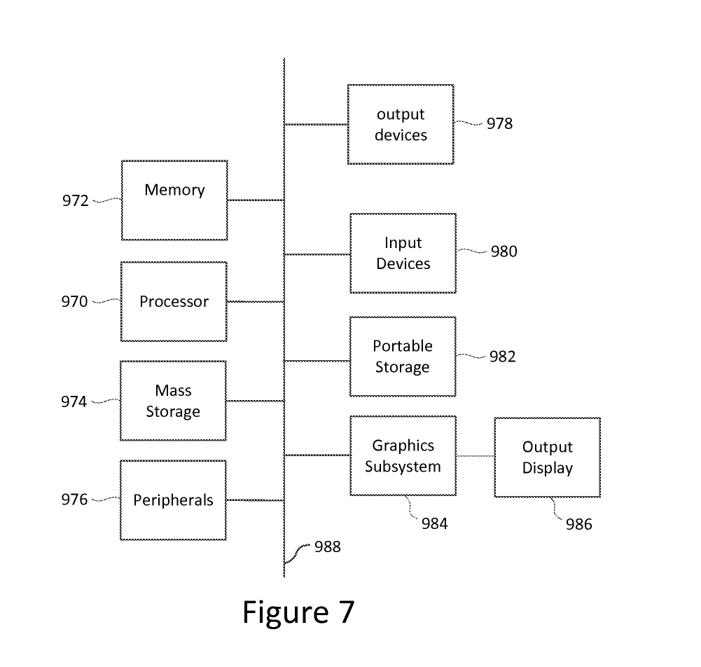

FIG. 7 illustrates a high level block diagram of a computer system which can be used to implement the technology described herein. The computer system could be used to implement electronic device 102. In some cases, multiple computer systems are used to implement the foregoing.

The computer system of FIG. 7 includes a processor unit 970 in communication with main memory 972. Processor unit 970 may contain a single microprocessor, or may contain a plurality of microprocessors for configuring the computer system as a multi-processor system. These one or more processors can perform the methods described above. Main memory 972 stores, in part, instructions and data for execution by processor unit 970. If the system described herein is wholly or partially implemented in software, main memory 972 can store the executable code when in operation. Main memory 972 may include banks of dynamic random access memory (DRAM) as well as high speed cache memory. For example, main memory 972 can store applications 112 and display logic 115.

The system of FIG. 7 further includes a mass storage device 974, peripheral device(s) 976, user input device(s) 980, output devices 978, portable storage medium drive(s) 982, a graphics subsystem 984 and an output display 986. For purposes of simplicity, the components shown in FIG. 7 are depicted as being connected via a single bus 988. However, the components may be connected through one or more data transport means. For example, processor unit 970 and main memory 972 may be connected via a local microprocessor bus, and the mass storage device 974, peripheral device(s) 976, portable storage medium drive(s) 982, and graphics subsystem 984 may be connected via one or more input/output (I/O) buses. Mass storage device 974, which may be implemented with a magnetic disk drive or an optical disk drive, is a non-volatile storage device for storing data and instructions for use by processor unit 970. In one embodiment, mass storage device 974 stores the system software for implementing the technology described herein for purposes of loading to main memory 972. Peripheral device(s) 976 may include any type of computer support device, such as an input/output (I/O) interface, to add additional functionality to the computer system. For example, peripheral device(s) 976 may include a network interface for connecting the computer system to a network, a modem, a router, etc.

User input device(s) 980 provides a portion of a user interface (e.g., to allow user to select an object 302 and indicate a direction to slide the object in its row. User input device(s) 980 may include an alpha-numeric keypad for inputting alpha-numeric and other information, or a pointing device, such as a mouse, a trackball, stylus, or cursor direction keys. In one embodiment, the output display 986 serves as a user input device (e.g., touch screen).

In order to display textual and graphical information, the computer system of FIG. 7 includes graphics subsystem 984 and output display 986. Output display 986 may include a touch screen, cathode ray tube (CRT) display, liquid crystal display (LCD) or other suitable display device. Graphics subsystem 984 receives textual and graphical information, and processes the information for output to display 986. Additionally, the system of FIG. 7 includes output devices 978. Examples of suitable output devices include speakers, printers, network interfaces, monitors, etc.

The components contained in the computer system of FIG. 7 are those typically found in computer systems suitable for use with the technology described herein, and are intended to represent a broad category of such computer components that are well known in the art. Thus, the computer system of FIG. 7 can be a personal computer, mobile computing device, smart phone, tablet, workstation, server, minicomputer, mainframe computer, or any other computing device. The computer can also include different bus configurations, networked platforms, multi-processor platforms, etc. Various operating systems can be used.

One embodiment disclosed herein includes a system comprising a display screen and a processor coupled to the display screen. The processor displays objects on the display screen. Each of the objects comprises a plurality of sequential portions. The displaying comprises displaying a first portion of each object in a row that is associated with that object. The first portion of each object comprises a first plurality of non-sequential items. The processor receives input that selects a first object of the objects and that indicates either a first direction or a second direction to slide the row associated with the first object. The processor accesses a second portion of the first object that corresponds to the direction of the slide. The second portion of the first object comprises a second plurality of non-sequential items, the processor removes the first portion from the display screen responsive to the input while continuing to display the first portion of the rest of the objects in their respective rows. The processor adds the second portion to the display screen responsive to the input while continuing to display the first portion of the rest of the objects in their respective rows.

One embodiment disclosed herein includes a computer program product comprising a computer readable storage medium having computer readable program code embodied therewith. The computer readable program code comprises computer readable program code configured to display objects on a display screen associated with an electronic device as a plurality or rows. Each of the objects comprises a plurality of streams of items. A first portion of each of the objects comprises a first item from each of the streams of items. The displaying comprises displaying the first portion of each object in a row that is associated with that object. The computer readable program code comprises computer readable program code configured to receive input at the electronic device that selects a first of the objects and that indicates either a first direction or a second direction to slide the row associated with the first object. The computer readable program code comprises computer readable program code configured to access a second portion of the first object that corresponds to the direction of the slide, the second portion of the first object comprises a second item from each of the plurality of streams of items of the first object. The computer readable program code comprises computer readable program code configured to slide the first portion of the first object in the indicated direction responsive to the input to remove the first portion from the display screen while continuing to display the first portion of the rest of the objects in their respective rows The computer readable program code comprises computer readable program code configured to slide the second portion of the first object in the indicated direction responsive to the input to add the second portion to the display screen while continuing to display the first portion of the rest of the objects in their respective rows.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of displaying objects, the method comprising:
displaying objects on a display screen associated with an electronic device, each of the objects comprises a plurality of sequential portions, the displaying comprises displaying a first portion of the plurality of sequential portions of each object in a row that is associated with that object, the first portion of each object comprises a first plurality of non-sequential items;
receiving input at the electronic device that selects a first object of the objects and that indicates either a first direction or a second direction to move within the first object;
accessing a second portion of the first object that corresponds to the direction of the move, the second portion of the first object comprises a second plurality of non-sequential items;
removing the first portion of the first object from the display screen responsive to the input while continuing to display the first portion of the rest of the objects in their respective rows; and
adding the second portion of the first object to the display screen in the row of the selected object responsive to the input while continuing to display the first portion of other objects in their respective rows.

2. The method of claim 1, wherein the receiving input at the electronic device comprises receiving a swipe selection of the first object that indicates either the first direction or the second direction,
the removing the first portion from the display screen comprises sliding the first portion of the first object in the indicated direction responsive to the input to remove the first portion from the display screen while continuing to display the first portion of the rest of the objects in their respective rows; and
the adding the second portion to the display screen comprises sliding the second portion of the first object in the indicated direction responsive to the input to add the second portion to the display screen while continuing to display the first portion of the rest of the objects in their respective rows.

3. The method of claim 1, wherein the second portion of the first object is downstream from the first portion of the first object, the input that selects the first object is first input that indicates a downstream direction, and further comprising:
receiving second input at the electronic device that selects the first object and indicates an upstream direction, the receiving occurs while displaying the second portion of the first object and the first portion of the rest of the objects;
removing the second portion from the display screen responsive to the second input while continuing to display the first portion of the rest of the objects in their respective rows; and
adding the first portion to the display screen responsive to the second input while continuing to display the first portion of the rest of the objects in their respective rows.

4. The method of claim 1, wherein the input that selects the first object is a first input, and further comprising:
receiving a second input that selects a second object of the objects that indicates either the first direction or the second direction to slide the row associated with the second object, the receiving the second input occurs while displaying the second portion of the first object with the first portion of the rest of the objects;
accessing a second portion of the second object that corresponds to the direction of the second input, the second portion of the second object comprises the second plurality of non-sequential items of the second object;
sliding the first portion of the second object in the indicated direction responsive to the second input to remove the first portion of the second object from the display screen; and
sliding the second portion of the second object in the indicated direction responsive to the second input to add the second portion of the second object to the display screen while continuing to display the second portion of the first object and the first portion of the rest of the objects in their respective rows.

5. The method of claim 1, wherein the first plurality of non-sequential items comprises a first image item and a first text item, the second plurality of non-sequential items comprises a second image item and a second text item.

6. The method of claim 1, wherein the number of items in the first plurality of non-sequential items is different from the number of items in the second plurality of non-sequential items.

7. The method of claim 1, wherein the first plurality of items and the second plurality of items of the first object together comprise a plurality of streams of items, displaying the first portion of the first object comprises displaying an initial item from a first stream of items and an initial item from a second stream of items of the first object, the sliding the second portion of the first object in the indicated direction responsive to the input to add the second portion to the display screen comprises displaying an item in the first stream that is downstream from the initial item in the first stream and displaying an item in the second stream that is downstream from the initial item in the second stream.

8. A system comprising:
a display screen; and
a processor coupled to the display screen and that displays objects on the display screen, each of the objects comprises a plurality of sequential portions, the displaying comprises displaying a first portion of each object in a row that is associated with that object, the first portion of each object comprises a first plurality of non-sequential items, the processor receives input that selects a first object of the objects and that indicates either a first direction or a second direction to slide the row associated with the first object, the processor accesses a second portion of the first object that corresponds to the direction of the slide, the second portion of the first object comprises a second plurality of non-sequential items, the processor removes the first portion from the display screen responsive to the input while continuing to display the first portion of the rest of the objects in their respective rows, the processor adds the second portion to the display screen responsive to the input while continuing to display the first portion of the rest of the objects in their respective rows.

9. The system of claim 8, wherein the processor receives a swipe selection on the display screen to receive the input, the swipe selects the first object and indicates either the first direction or the second direction, the processor slides the first portion of the first object in the indicated direction to remove the first portion from the display screen while continuing to display the first portion of the rest of the objects in their respective rows, the processor slides the second portion of the first object in the indicated direction responsive to the input to add the second portion to the display screen while continuing to display the first portion of the rest of the objects in their respective rows.

10. The system of claim 8, wherein the second portion of the first object is downstream from the first portion of the first object, the input is first input that indicates a downstream direction, and wherein the processor receives second input that selects the first object and indicates an upstream direction, the processor removes the second portion from the display screen responsive to the second input while continuing to display the first portion of the rest of the objects in their respective rows, the processor adds the first portion to the display screen responsive to the second input while the processor continues to display the first portion of the rest of the objects in their respective rows.

11. The system of claim 8, wherein the input is a first input, and wherein the processor receives a second input that selects a second object of the objects that indicates either the first direction or the second direction to slide the row associated with the second object, the processor accesses a second portion of the second object that corresponds to the direction of the second input, the second portion of the second object comprises the second plurality of non-sequential items of the second object, the processor slides the first portion of the second object in the indicated direction responsive to the second input to remove the first portion of the second object from the display screen, the processor slides the second portion of the second object in the indicated direction responsive to the second input to add the second portion of the second object to the display screen while continuing to display the second portion of the first object and the first portion of the rest of the objects in their respective rows.

12. The system of claim 8, wherein the first plurality of non-sequential items comprises a first image item and a first text item, the second plurality of non-sequential items comprises a second image item and a second text item.

13. The system of claim 8, wherein the number of items in the first plurality of non-sequential items is different from the number of items in the second plurality of non-sequential items.

14. The system of claim 8, wherein the first plurality of items and the second plurality of items of the first object together comprise a plurality of streams of items, the processor displays an initial item from a first of the plurality of streams of items and an initial item from a second of the plurality of streams of items of the first object on the display screen, the processor slides the second portion of the first object in the indicated direction responsive to the input to add the second portion to the display screen to display an item in the first stream that is downstream from the initial item in the first stream and to display an item in the second stream that is downstream from the initial item in the second stream.

15. A computer program product comprising:
a computer readable storage medium having computer readable program code embodied therewith, the computer readable program code comprising:
computer readable program code configured to display objects on a display screen associated with an electronic device as a plurality or rows, each of the objects comprises a plurality of streams of items, a first portion of each of the objects comprises a first item from each of the streams of items, the displaying comprises displaying the first portion of each object in a row that is associated with that object;
computer readable program code configured to receive input at the electronic device that selects a first of the objects and that indicates either a first direction or a second direction to slide the row associated with the first object;
computer readable program code configured to access a second portion of the first object that corresponds to the direction of the slide, the second portion of the first object comprises a second item from each of the plurality of streams of items of the first object;
computer readable program code configured to slide the first portion of the first object in the indicated direction responsive to the input to remove the first portion from the display screen while continuing to display the first portion of the rest of the objects in their respective rows; and
computer readable program code configured to slide the second portion of the first object in the indicated direction responsive to the input to add the second portion to the display screen while continuing to display the first portion of the rest of the objects in their respective rows.

16. The computer program product of claim 15, wherein the computer readable program code configured to receive input at the electronic device is further configured to receive a swipe selection of the first object that indicates either the first direction or the second direction.

17. The computer program product of claim 15, wherein the second portion of the first object is downstream from the first portion of the first object, the input indicates a downstream direction, and further comprising:
computer readable program code configured to receive second input at the electronic device that selects the first object and indicates an upstream direction, the receiving occurs while displaying the second portion of the first object and the first portion of the rest of the objects;
computer readable program code configured to slide the second portion of the first object in the upstream direction responsive to the second input to remove the second portion from the display screen while continuing to display the first portion of the rest of the objects in their respective rows; and
computer readable program code configured to slide the first portion of the first object in the upstream direction responsive to the second input to add the first portion to the display screen while continuing to display the first portion of the rest of the objects in their respective rows.

18. The computer program product of claim 15, further comprising:
computer readable program code configured to receive a second input that selects a second object of the objects that indicates either the first direction or the second direction to slide the row associated with the second object, receiving the second input occurs while displaying the second portion of the first object with the first portion of the rest of the objects;
computer readable program code configured to access a second portion of the second object that corresponds to the direction of the second input, the second portion of the second object comprises a second item from each of the plurality of streams of items of the second object;
computer readable program code configured to slide the first portion of the second object in the indicated direction responsive to the second input to remove the first portion of the second object from the display screen; and
computer readable program code configured to slide the second portion of the second object in the indicated direction responsive to the second input to add the second portion of the second object to the display screen while continuing to display the second portion of the first object and the first portion of the rest of the objects in their respective rows.

19. The computer program product of claim 15, wherein the first portion of the first object comprises a first image item and a first text item, the second portion of the first object comprises a second image item and a second text item.

20. The computer program product of claim 15, wherein the number of items in the first portion of the first object is different from the number of items in the second portion of the first object.
